(19) United States
(12) Patent Application Publication
(10) Pub. No.: US 2002/0016791 A1
(43) Pub. Date: Feb. 7, 2002

(54) Computer-implemented system and method for recruiting athletes

(76) Inventor: Roger L. Palmer, Wilmington, DE (US)

Correspondence Address: CONNOLLY BOVE LODGE & HUTZ LLP, James M. Olsen, 1220 Market Street, P.O. Box 2201, Wilmington, DE, 19899, US

(21) Appl. No.: 09/917,991

(22) Filed: Jul. 30, 2001

Related U.S. Application Data
(60) Provisional application No. 60/222,423, filed on Aug. 1, 2000.

(51) Int. Cl. G06F 17/30

(52) U.S. Cl. 707/104.1; 707/10

(57) ABSTRACT

A computer-implemented system and method for recruiting athletes that provides a recruiting mechanism where high school athletes can search recruiting information provided by numerous colleges and universities, enabling the athletes to match their skills with schools seeking their specific skills. The system includes a searchable database of recruiting information provided by individual schools, and a search criteria input system that provides athletes with various search criteria from which they may choose to vary the scope of a search of schools. The system further includes a school display system which displays recruiting information about the schools matching the search criteria inputted by the athletes.

### CLAIM OF PRIORITY

Priority is claimed under 35 U.S.C. §119(e) from U.S. Provisional Application Ser. No. 60/222,423 that was filed Aug. 1, 2000. The prior application is herein incorporated by reference in its entirety.

### BACKGROUND OF THE INVENTION

A. Field of the Invention

The present invention relates generally to the Internet, and, more particularly to a computer-implemented system and method for recruiting athletes.

B. Description of the Related Art

The globally-linked network of computers known as the Internet presents many opportunities today. The world-wide web (WWW), which is one of the facilities provided on top of the Internet, comprises many pages or files of information, distributed across many different server computer systems. Information stored on such pages can be presented to the user's computer system (“client computer system”) using a combination of text, graphics, audio data and video data. Each page is identified by a Universal Resource Locator (URL). The URL denotes both the server machine, and the particular file or page on that machine. There may be many pages or URLs resident on a single server.

In order to use the WWW, a client computer system runs a piece of software known as a graphical web browser, such as the Navigators program available from Netscape® Communications Corporation. The client computer system interacts with the browser to select a particular URL, which in turn causes the browser to send a request for that URL or page to the server identified in the URL. Typically the server responds to the request by retrieving the requested page, and transmitting the data for that page back to the requesting client computer system (the client/server interaction is performed in accordance with the hypertext transport protocol (“HTTP”)). This page is then displayed to the user on the client screen. The client may also cause the server to launch an application, for example to search for WWW pages relating to particular topics.

Most WWW pages are formatted in accordance with a computer program written in a language known as HTML (hypertext markup language). This program contains the data to be displayed via the client's graphical browser as well as formatting commands which tell the browser how to display the data. Thus a typical web page includes text together with embedded formatting commands, referred to as tags, which can be used to control the font size, the font style (for example, whether italic or bold), how to layout the text, and so on. A web browser “parses” the HTML script in order to display the text in accordance with the specified format. HTML tags are also used to indicate how graphics, audio and video are manifested to the user via the client's browser.

Recruiting athletes for collegiate sports is an expensive and time-consuming endeavor for universities and colleges. Such costs and time constraints typically do not present problems for large universities with their large recruiting networks and budgets, but do make it difficult for smaller universities and colleges to recruit qualified athletes. Individual colleges and universities provide electronic recruiting forms on their web sites in which athletes can submit information about themselves to a particular college or university. An athlete, unfortunately, must visit the web sites of each of the schools they are interested in and provide the same type of information at each web site. This is a cumbersome process. The athlete further does not know whether his or her particular skills are well-suited for the schools to which they are submitting the information.

A handful of private recruiters provide their services to high school athletes via the Internet, see for example, www.recruitzone.com and www.collegerecruiting.com. Such private recruiter web sites require a high school athlete to fill out an electronic form and submit it with a fee to the private recruiter. The private recruiter, in turn, personally contacts a number universities and colleges about the athlete(s) he/she represents, hoping to find a match for the athlete(s) and the schools.

Thus, there is a need in the art to provide a recruiting mechanism where colleges provide their recruiting information and high school athletes can search such information, and athletes do not have to pay to submit information to recruiters. There is a further need in the art to provide a mechanism for athletes to search a database of numerous colleges to enable the athletes to match their skills with schools seeking their specific skills.

### SUMMARY OF THE INVENTION

The present invention satisfies the need in the art by providing a computer-implemented system and method for recruiting athletes. The system and method of the present invention provides a recruiting mechanism where colleges provide their recruiting information and high school athletes can search such information, and athletes do not have to pay to submit information to recruiters. The system and method further enables athletes to search a database of numerous colleges, allowing the athletes to match their skills with schools seeking their specific skills.

Additional advantages of the invention will be set forth in part in the description which follows, and in part will be learned from the description, or may be learned by practice of the invention. The advantages of the invention will be realized and attained by means of the elements and combinations particularly pointed out in the appended claims.

In accordance with the purpose of the invention, as embodied and broadly described herein, the invention comprises a computer-implemented system which implements a program for recruiting athletes, the system comprising: a search criteria input system which implements an electronic search input process, the criteria input system providing athletes with various search criteria from which athletes may choose to vary the scope of a search for schools seeking athletes; and a school display system which displays recruiting information about the schools matching the search criteria inputted by the athletes.

Further in accordance with the purpose of the invention, the invention comprises a computer-implemented method for recruiting athletes comprising the steps of: providing a Web site that includes a searchable database of schools seeking to recruit athletes; providing a search criteria input system which implements an electronic search input process, the criteria input system providing athletes with various search criteria from which athletes may choose to vary the scope of a search for schools seeking athletes; and providing a school display system which displays recruiting information about the schools matching the search criteria inputted by the athletes, the recruiting information being stored in the searchable database of the Web site.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate one embodiment of the invention and together with the description, serve to explain the principles of the invention. In the drawings:

FIG. 1 is a schematic diagram showing a system of an embodiment of the present invention;

FIG. 2 is a schematic diagram showing a client entity, server entity, or client/server entity of the system of FIG. 1;

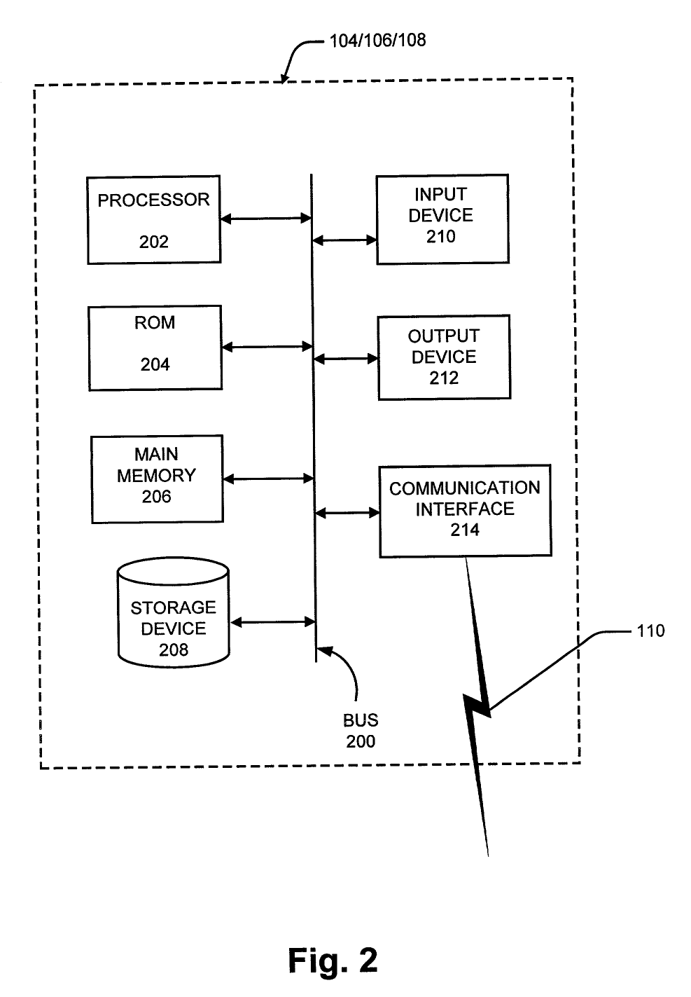

FIG. 3 is a schematic diagram showing the primary components of the system shown in FIG. 1;

FIG. 4 is a flow chart of processing performed by the system shown in FIG. 1;

FIG. 5 is a schematic diagram showing a home web page displayed by the system shown in FIG. 1;

FIG. 6 is a schematic diagram showing a search results web page displayed by the system of FIG. 1;

FIG. 7 is a schematic diagram showing a detail web page for an individual school as displayed by the system of FIG. 1; and

FIG. 8 is a schematic diagram showing a school information input web page as displayed by the system of FIG. 1.

### DESCRIPTION OF THE PREFERRED EMBODIMENT

Reference will now be made in detail to the present preferred embodiment of the invention, an example of which is illustrated in the accompanying drawings. Wherever possible, the same reference numbers will be used throughout the drawings to refer to the same or like parts.

The present invention is broadly drawn to a computer-implemented system and method for recruiting athletes. The system and method of the present invention provides a recruiting mechanism where athletes can search recruiting information from numerous schools, allowing the athletes to match their skills with schools seeking their specific skills.

A. Network Description

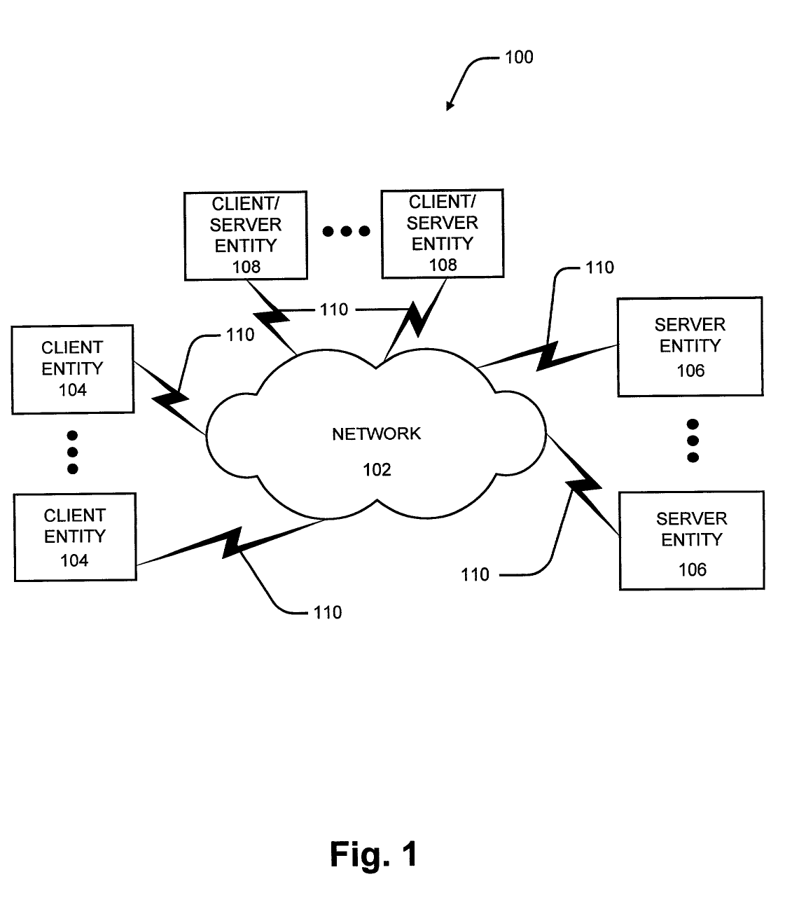

In accordance with the invention and as shown in FIG. 1, the system 100 of the present invention includes a network 102 that interconnects client entities 104, server entities 106 and client/server entities 108 via communication links 110.

Network 102 may comprise an Internet, intranet, extranet, local area network (LAN), wide area network (WAN), metropolitan area network (MAN), telephone network such as the public switched telephone network (PSTN), or a similar network.

The Internet is a collection of interconnected (public and/or private) networks that are linked together by a set of standard protocols (such as TCP/IP and HTTP) to form a global, distributed network. While this term is intended to refer to what is now commonly known as the Internet, it is also intended to encompass variations which may be made in the future, including changes and additions to existing protocols.

An intranet is a private network that is contained within an enterprise. It may consist of many interlinked local area networks and also use leased lines in the wide area network. Typically, an intranet includes connections through one or more gateway computers to the outside Internet. The main purpose of an intranet is to share company information and computing resources among employees. An intranet can also be used to facilitate working in groups and for teleconferences. An intranet uses TCP/IP, HTTP, and other Internet protocols and in general looks like a private version of the Internet. With tunneling, companies can send private messages through the public network, using the public network with special encryption/decryption and other security safeguards to connect one part of their intranet to another. Typically, larger enterprises allow users within their intranet to access the public Internet through firewall servers that have the ability to screen messages in both directions so that company security is maintained. When part of an intranet is made accessible to customers, partners, suppliers, or others outside the company, that part becomes part of an extranet.

An extranet is a private network that uses the Internet protocols and the public telecommunication system to securely share part of a business's information or operations with suppliers, vendors, partners, customers, or other businesses. An extranet can be viewed as part of a company's intranet that is extended to users outside the company.

A LAN refers to a network where computing resources such as PCs, printers, minicomputers, and mainframes are linked by a common transmission medium such as coaxial cable. A LAN usually refers to a network in a single building or campus. A WAN is a public or private computer network serving a wide geographic area. A MAN is a data communication network covering the geographic area of a city, a MAN is generally larger than a LAN but smaller than a WAN.

PSTN refers to the world's collection of interconnected voice-oriented public telephone networks, both commercial and government-owned. It is the aggregation of circuit-switching telephone networks that has evolved from the days of Alexander Graham Bell. Today, PSTN is almost entirely digital in technology except for the final link from the central (local) telephone office to the user. In relation to the Internet, the PSTN actually furnishes much of the Internet's long-distance infrastructure.

An entity may include software, such as programs, threads, processes, information, databases, or objects; hardware, such as a computer, a laptop, a personal digital assistant (PDA), a wired or wireless telephone, or a similar wireless device; or a combination of both software and hardware. A client entity 104 is an entity that sends a request to a server entity and waits for a response. A server entity 106 is an entity that responds to the request from the client entity. A client/server entity 108 is an entity where the client and server entities reside in the same piece of hardware or software.

Connections 110 may be wired, wireless, optical or a similar connection mechanisms. “Wireless” refers to a communications, monitoring, or control system in which electromagnetic or acoustic waves carry a signal through atmospheric space rather than along a wire. In most wireless systems, radio-frequency (RF) or infrared (IR) waves are used. Some monitoring devices, such as intrusion alarms, employ acoustic waves at frequencies above the range of human hearing.

An entity, whether it be a client entity 104, a server entity 106, or a client/server entity 108, includes a bus 200 interconnecting a processor 202, a read-only memory (ROM) 204, a main memory 206, a storage device 208, an input device 210, an output device 212, and a communication interface 214. Bus 200 is a network topology or circuit arrangement in which all devices are attached to a line directly and all signals pass through each of the devices. Each device has a unique identity and can recognize those signals intended for it. Processor 202 includes the logic circuitry that responds to and processes the basic instructions that drive entity 104, 106, 108. ROM 204 includes a static memory that stores instructions and date used by processor 202.

Computer storage is the holding of data in an electromagnetic form for access by a computer processor. Main memory 206, which may be a RAM or another type of dynamic memory, makes up the primary storage of entity 104, 106, 108. Secondary storage of entity 104, 106, 108 may comprise storage device 208, such as hard disks, tapes, diskettes, Zip drives, RAID systems, holographic storage, optical storage, CD-ROMs, magnetic tapes, and other external devices and their corresponding drives.

Input device 210 may include a keyboard, mouse, pointing device, sound device (e.g. a microphone etc.), biometric device, or any other device providing input to entity 104, 106, 108. Output device 212 may comprise a display, a printer, a sound device (e.g. a speaker, etc.), or other device providing output to entity 104, 106, 108. Communication interface 214 may include network connections, modems, or other devices used for communications with other computer systems or devices.

As will be described below, an entity 104, 106, 108 consistent with the present invention may perform a method for recruiting athletes for collegiate sports. Entity 104, 106, 108 performs this task in response to processor 202 executing sequences of instructions contained in a computer-readable medium, such as main memory 206. A computer-readable medium may include one or more memory devices and/or carrier waves.

Execution of the sequences of instructions contained in main memory 206 causes processor 202 to perform processes that will be described later. Alternatively, hardwired circuitry may be used in place of or in combination with software instructions to implement processes consistent with the present invention. Thus, the present invention is not limited to any specific combination of hardware circuitry and software.

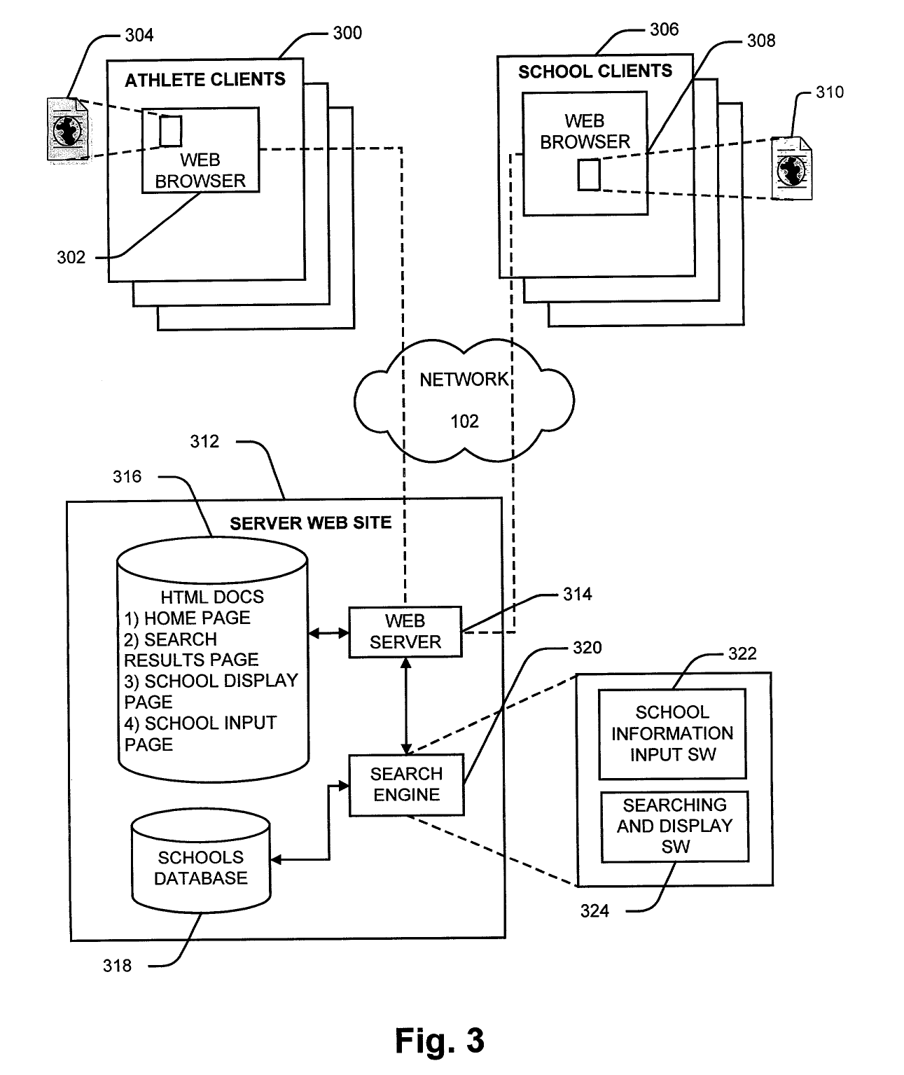

As shown in FIG. 3, network 102 interconnects athlete client entities 300 and school client entities 306 with a server web site entity 312. Athlete client entities 300 have web browsers 302 that allow the athlete client entities 300 to interactively browse web sites and web documents 304 contained therein. School client entities 306 similarly have web browsers 308 that allow the school client entities 306 to interactively browse web sites and web documents 310 contained therein.

Server web site entity 312 contains a web server 314 that interconnects with a database 316 containing HTML documents such as a Home page, Search Results page, School Display page, and School Input page, as described below. Web server 314 further connects to a search engine 320 capable of running a plurality of software processes such as School Information Input software 322, and Searching and Display software 324. Search engine 320 connects to a database 318 for storage of information provided by school client entities 306.

As used herein the term “athlete” encompasses a person or persons, male or female, who wants to participate in collegiate athletics. The term “school” encompasses any college or university offering collegiate athletics.

B. Network Processing

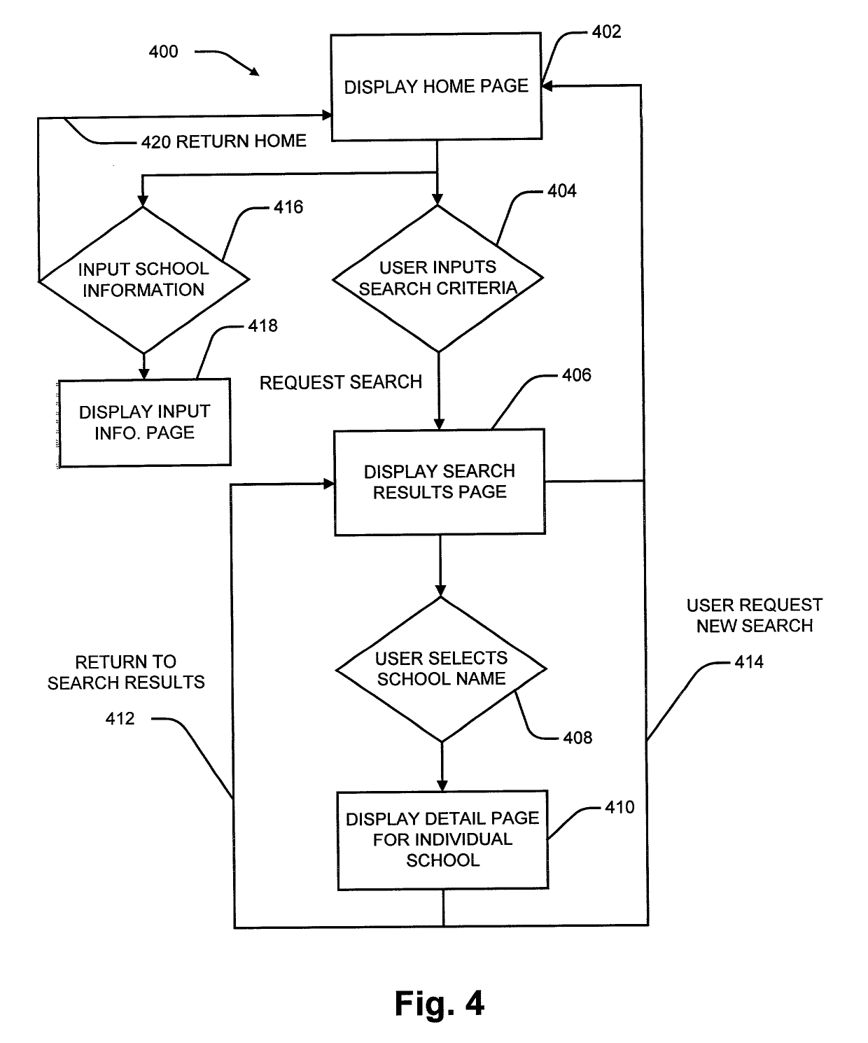

FIG. 4 shows a schematic diagram of some of the processing performed by server web site entity 312 shown in FIG. 3, as generally designated by reference numeral 400. When athlete client entity 300 or school client entity 306 enters server web site 312, web server 314 displays a Home page at step 402. At step 404, a user inputs search criteria and requests a search. As used herein, a “user” may encompass any athlete or school. At step 406, web server 314 displays a Search Results page, displaying a list of schools matching the search criteria inputted by the user. The user may return to the Home page from the Search Results page, and request a new search. At step 408, the user then selects a school name displayed on the Search Results page, and web server 314 displays a detailed page for the selected school at step 410. From the detailed school page, the user may return to the Search Results page, at step 412, or to the Home page, at step 414, and request a new search.

Alternatively, if the user is a school, the user may choose to go to an input school information web page at step 416. Process 400 then displays the school information input page at step 418, and the school may input new or update information regarding a particular sport program. The school may then request to return to the Home page as shown by reference numeral 420.

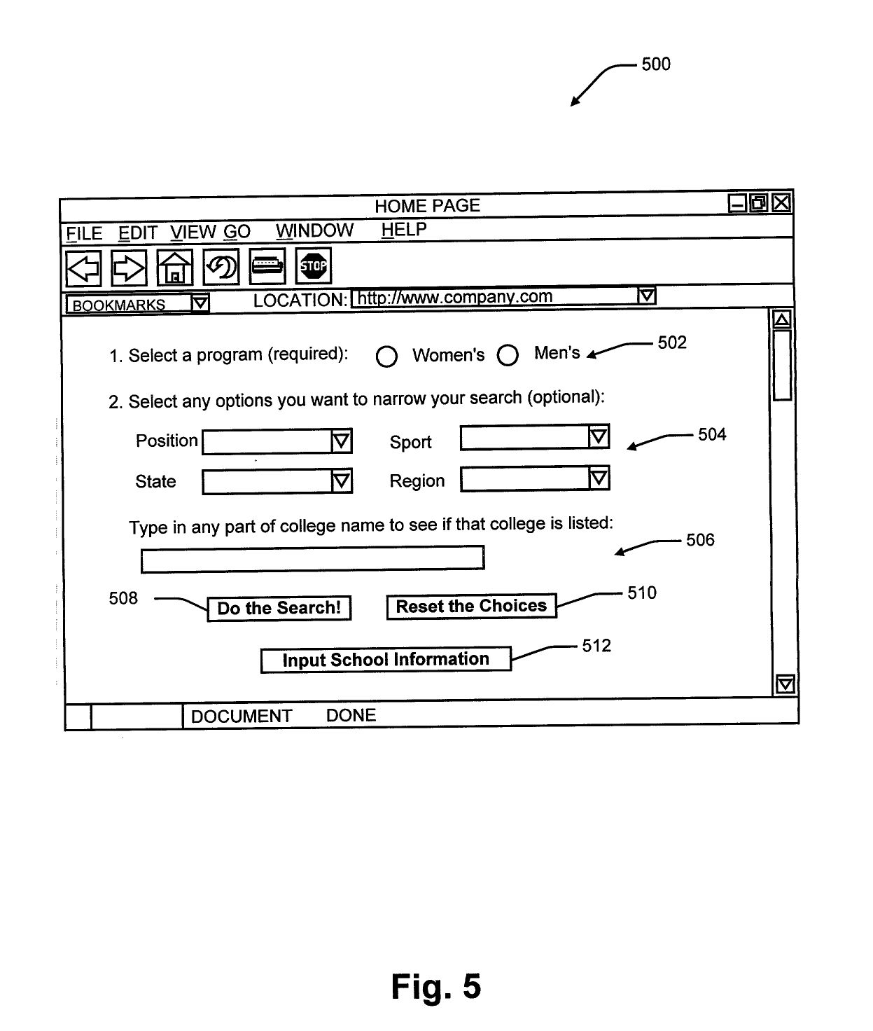

FIG. 5 shows a schematic diagram of the Home page, shown generally as reference numeral 500. In addition to text discussing the purpose of the web site (not shown), Home page 500 displays a variety of search criteria from which a user may choose to narrow the scope of the search for a school. The user may select whether the program is a Women's or Men's program at section 502 of Home page 500. The user may select some, all, or any combination of the options shown at section 504 of Home page 500, including but not limited to the position sought by the athlete, the state where the school is located, the sport sought to be played by the athlete, and the region of the country where the school is located. The user inputs the information at section 504 by using pulldown menus listing the possible selections for each option. Alternatively, at section 506 the user may type in any part of a college name to see if that college is listed in school information database 318 stored on server web site 312. Once the user has inputted the desired search criteria, a search is conducted by selecting a “Do the Search!” button 508 provided on Home page 500. The user may also reset the search criteria by selecting a “Reset the Choices” button 510 provided on Home page 500. Finally, a school may select an “Input School Information” button 512, wherein the input school information web page is displayed.

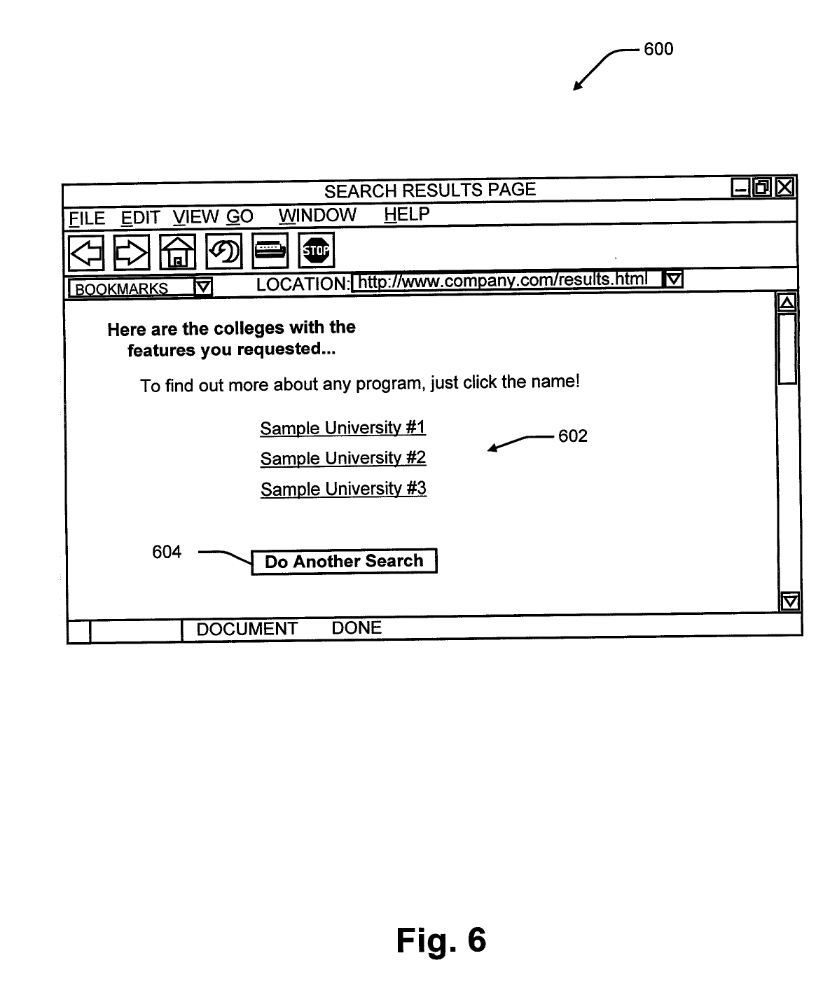

FIG. 6 shows a schematic diagram of a Search Results page 600. Search engine 320 compares the user-inputted search criteria to the information contained in schools database 318. Web server 314 displays the schools in database 318 matching the user-inputted search criteria as hyperlinks 602 on Search Results page 600. As is well known in the art, hyperlinks are subroutines which permit the user to simply highlight or click on the desired link, and the appropriate behind-the-scenes processing occurs such that the desired data is downloaded to the user's computer. Each hyperlink 602 lists the name of the school and provides a link to the recruiting information about that school. Search Results page 600 also provides a “Do Another Search” button 604 that enables the user to return to Home page 500 so that new search criteria may be inputted by the user.

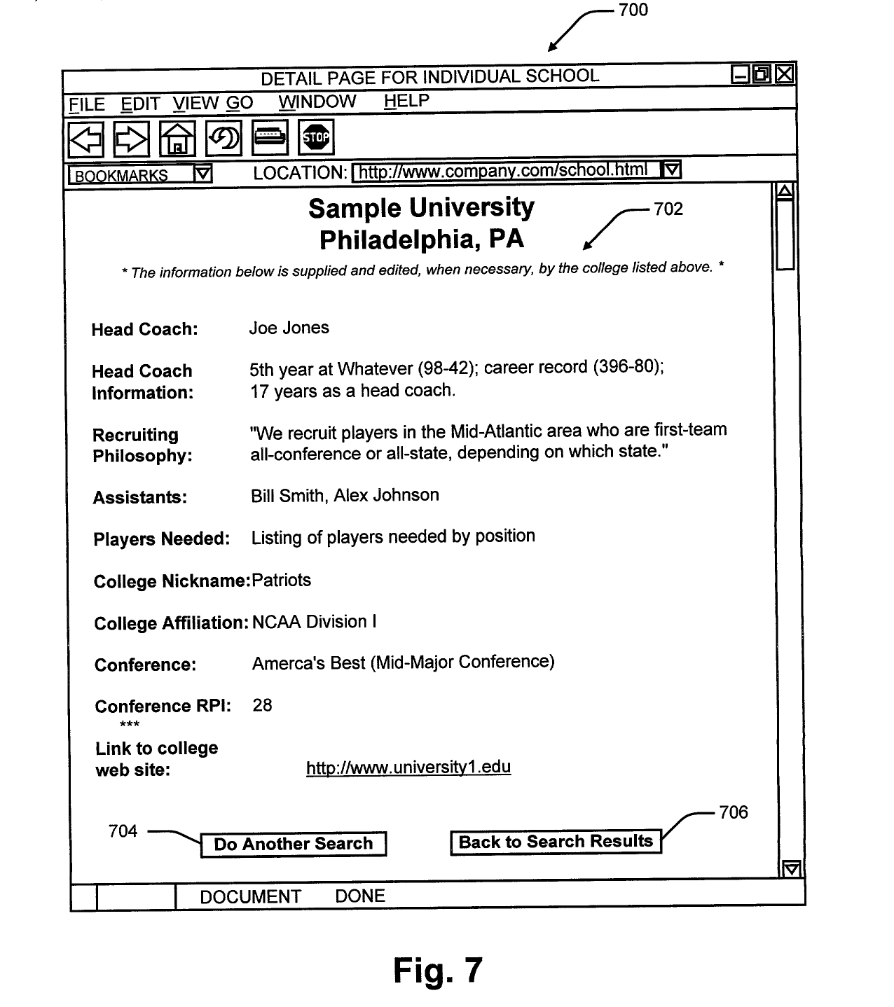

FIG. 7 shows a schematic diagram of a detail page 700 for an individual school. Section 702 of detail page 700 provides a detailed description of the school and sport matching the user's search criteria. Section 702 may provide information relating but not limited to: Head Coach name; Head Coach Information; Recruiting Philosophy; Assistant Coach name(s); Players Needed, which may be listed by position depending upon the sport selected; College Nickname; College Affiliation; Conference; Conference's NCAA Ratings Percentage Index (RPI); previous year record; RPI/Dunkel Index Rating; previous year accomplishments; record for the past three years; accomplishments for the past three years; and link to the school's web site. Detail page 700 also provides a “Do Another Search” button 704 that enables the user to return to Home page 500 so that new search criteria may be inputted by the user. Detail page 700 also includes a “Back to Search Results” button 706 that returns the user to Search Results page 600, enabling the user to select another school found in the search.

The Dunkel Index (see www.dunkelindex.com) is a progressive statistical formula that has historically proven to be an accurate measurement when applied to the performance of an organized group of athletes versus another organized group of athletes. It is the one of the few known formulas to incorporate the strength of one team's schedule against another's. The Index basically reflects all the intangibles that can affect the performance of any team, on any given day, regardless of the circumstances.

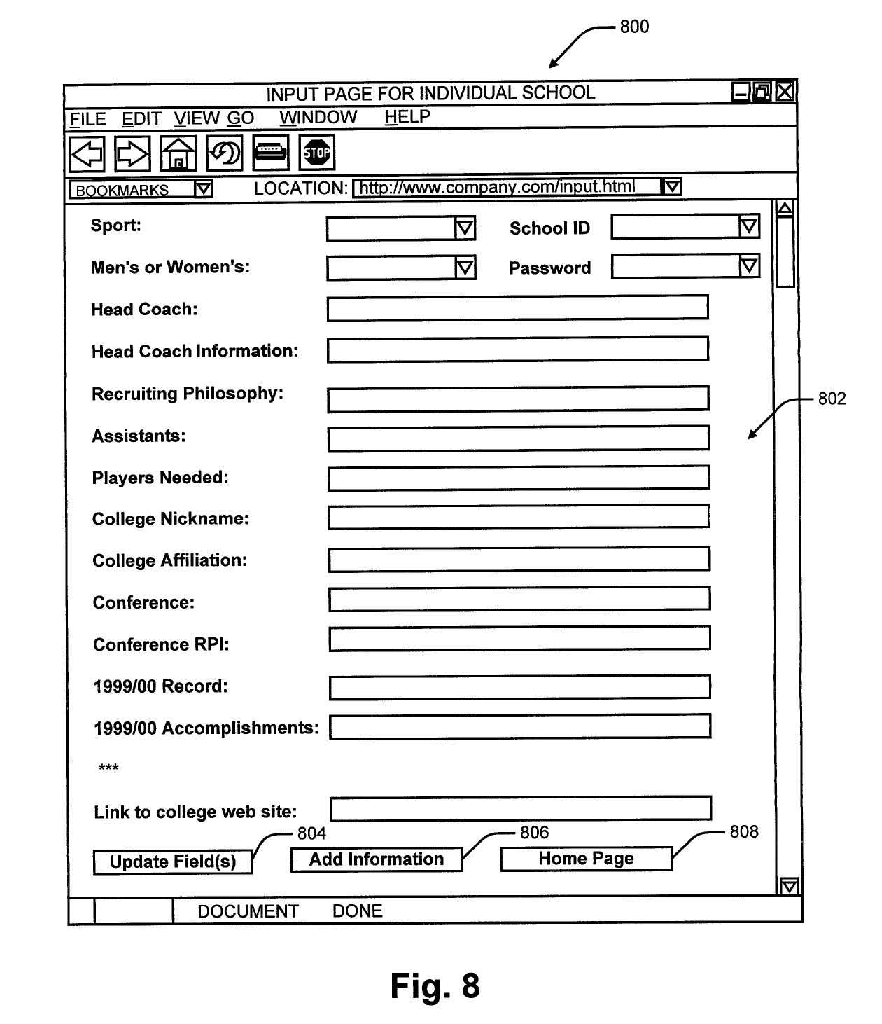

FIG. 8 shows a schematic diagram of an input school information web page 800. Section 802 if input page 800 provides fields for inputting detailed information about a school's sports program. Section 802 requires that the school input their school name, preferably from a drop down menu, and their assigned password. Before a school may post information on server web site 312, the school must sign up to become a member of server web site 312. Once a school is a member of server web site 312, server web site assigns the school an identification (“ID”) and a password so that they may input and/or update information about their sports programs. Section 802 may provide input fields relating but not limited to: the particular sport; whether it's a men's or women's sport; Head Coach name; Head Coach Information; Recruiting Philosophy; Assistant Coach name(s); Players Needed, which may be listed by position depending upon the sport selected; College Nickname; College Affiliation; Conference; Conference's RPI; previous year record; RPI/Dunkel Index Rating; previous year accomplishments; record for the past three years; accomplishments for the past three years; and link to the school's web site.

A school may choose to update only certain fields, in which case they would select an “Update Field(s)” button 804 provided on Input page 800. If a school is inputting the information for the first time, then they would select an “Add Information” button 806. After the “Update Field(s)” button 804 or “Add Information” button 806 is selected, server web site 312 checks to see if the school is a member of web site 312 and verifies the inputted ID and password. If the school is a member and the ID and password are correct, server web site 312 either updates or adds the information about the school sports program in schools database 318. Input page 800 also provides a “Return Home” button 808 that enables the user to return to Home page 500.

Alternatively, schools may provide updates or information to the server web site 312 via telephone, mail, etc. A person working with the server web site 312 then manually inputs the updates information directly into schools database 318.

It will be apparent to those skilled in the art that various modifications and variations can be made in the system and method of the present invention and in construction of this system and method without departing from the scope or spirit of the invention. As an example, the present invention may be used by schools to provide online recruiting information to musicians, students proficient in particular subjects, actors, etc.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for recruiting athletes, comprising:
providing a Web site that includes a searchable database of schools seeking to recruit athletes;
providing a search criteria input system which implements an electronic search input process, the criteria input system providing athletes with various search criteria from which athletes may choose to vary the scope of a search for schools seeking athletes; and
providing a school display system which displays recruiting information about the schools matching the search criteria inputted by the athletes, the recruiting information being stored in the searchable database of the Web site.

2. A computer-implemented method for recruiting athletes as recited in claim 1, further comprising:
displaying detailed recruiting information about a school selected by the athletes.

3. A computer-implemented method for recruiting athletes as recited in claim 1, wherein the search criteria comprises one of a position sought by the athlete, a state where a school is located, a sport sought to be played by the athlete, and a region of the country where a school is located.

4. A computer-implemented method for recruiting athletes as recited in claim 1, wherein the athlete may type in any part of a school name to see if that college is listed in the searchable database of the Web site.

5. A computer-implemented method for recruiting athletes as recited in claim 1, wherein the providing a school display system step comprises comparing a search criteria inputted by the athlete to information listed in the searchable database of the Web site.

6. A computer-implemented method for recruiting athletes as recited in claim 2, wherein the detailed recruiting information about a school selected by the athletes comprises one of head coach name, head coach information, recruiting philosophy, assistant coach name(s), players needed, college nickname, college affiliation, conference, the conference NCAA Ratings Percentage Index (RPI), previous year record, RPI/Dunkel index rating, previous year accomplishments; record for the past three years, accomplishments for the past three years, and link to the school web site.

7. A system for recruiting athletes, the system comprising:
a memory configured to store instructions; and
a processor configured to execute instructions for:
providing a Web site that includes a searchable database of schools seeking to recruit athletes,
providing a search criteria input system which implements an electronic search input process, the criteria input system providing athletes with various search criteria from which athletes may choose to vary the scope of a search for schools seeking athletes, and
providing a school display system which displays recruiting information about the schools matching the search criteria inputted by the athletes, the recruiting information being stored in the searchable database of the Web site.

8. A system for recruiting athletes as recited in claim 7, wherein the processor is further configured to execute instructions for displaying detailed recruiting information about a school selected by the athletes.

9. A system for recruiting athletes as recited in claim 7, wherein the search criteria comprises one of a position sought by the athlete, a state where a school is located, a sport sought to be played by the athlete, and a region of the country where a school is located.

10. A system for recruiting athletes as recited in claim 7, wherein the athlete may type in any part of a school name to see if that college is listed in the searchable database of the Web site.

11. A system for recruiting athletes as recited in claim 7, wherein the providing a school display system instruction comprises comparing a search criteria inputted by the athlete to information listed in the searchable database of the Web site.

12. A system for recruiting athletes as recited in claim 8, wherein the detailed recruiting information about a school selected by the athletes comprises one of head coach name, head coach information, recruiting philosophy, assistant coach name(s), players needed, college nickname, college affiliation, conference, the conference NCAA Ratings Percentage Index (RPI), previous year record, RPI/Dunkel index rating, previous year accomplishments; record for the past three years, accomplishments for the past three years, and link to the school web site.

13. A computer readable medium that stores instructions executable by at least one processor to perform a method for recruiting athletes, comprising instructions for:
providing a Web site that includes a searchable database of schools seeking to recruit athletes;
providing a search criteria input system which implements an electronic search input process, the criteria input system providing athletes with various search criteria from which athletes may choose to vary the scope of a search for schools seeking athletes; and
providing a school display system which displays recruiting information about the schools matching the search criteria inputted by the athletes, the recruiting information being stored in the searchable database of the Web site.

14. A computer readable medium as recited in claim 13, wherein the processor further executes instructions for displaying detailed recruiting information about a school selected by the athletes.

15. A computer readable medium as recited in claim 13, wherein the search criteria comprises one of a position sought by the athlete, a state where a school is located, a sport sought to be played by the athlete, and a region of the country where a school is located.

16. A computer readable medium as recited in claim 13, wherein the athlete may type in any part of a school name to see if that college is listed in the searchable database of the Web site.

17. A computer readable medium as recited in claim 13, wherein the providing a school display system instruction comprises comparing a search criteria inputted by the athlete to information listed in the searchable database of the Web site.

18. A computer readable medium as recited in claim 14, wherein the detailed recruiting information about a school selected by the athletes comprises one of head coach name, head coach information, recruiting philosophy, assistant coach name(s), players needed, college nickname, college affiliation, conference, the conference NCAA Ratings Percentage Index (RPI), previous year record, RPI/Dunkel index rating, previous year accomplishments; record for the past three years, accomplishments for the past three years, and link to the school web site.
